(19) United States
(12) Patent Application Publication
(10) Pub. No.: US 2017/0168670 A1
(43) Pub. Date: Jun. 15, 2017

(54) METHOD AND SYSTEM FOR CREATING CONTENT SHORTCUT

(71) Applicant: Samsung Electronics Co., Ltd., Gyeonggi-do (KR)

(72) Inventors: Susnata SOVALIN, Noida (IN); Bhaskar DUTTA, Noida (IN); Abhishek CHANDRA, Noida (IN)

(73) Assignee: Samsung Electronics Co., Ltd.

(21) Appl. No.: 15/380,198

(22) Filed: Dec. 15, 2016

(30) Foreign Application Priority Data
Dec. 15, 2015 (IN) 4117/DEL/2015
Dec. 15, 2015 (KR) 10-2016-0171493

(51) Int. Cl. G06F 3/0482; G06F 17/24; H04L 29/06; G06F 17/22

(52) U.S. Cl. CPC G06F 3/0482; G06F 17/2235; G06F 17/241; H04L 65/607; H04L 65/1003; H04L 67/42

(57) ABSTRACT

An electronic device, a controlling method thereof, and a server device are provided. The electronic device includes a display, a communicator configured to communicate with a server, and a processor configured to obtain information on a start point and an end point to create a shortcut file of a portion of a content displayed on the display according to a user input and transmit the information to the server through the communicator, and in response to the content being selected according to a user input, receive, from the server, information on a shortcut file on a portion of the content created based on information on the start point and the end point and a pre-stored different shortcut file relating to the content, and provide the information to the display.

### CROSS-REFERENCE TO RELATED APPLICATION

This application is based on and claims priority under 35 U.S.C. §119 to Indian Patent Application No. 4117/DEL/2015, filed on Dec. 15, 2015, in the Indian Intellectual Property Office, and Korean Patent Application No. 10-2016-0171493, filed on Dec. 15, 2016, in the Korean Intellectual Property Office, the disclosures of which are incorporated herein by reference in their entirety.

### BACKGROUND

1. Field

The present disclosure relates generally to multimedia content, and particularly to creating content shortcut.

2. Description of Related Art

With rapid expansion of streaming technology and streamer server in home network, a user can set up a home network including two or three client devices such as audio-visual device and television client, and only one server. The server is capable of receiving broadcast signal and includes integrated personal recorder to record a video content from the broadcast signal for viewing at a later time and an integrated internal hard drive. In addition, the server includes a hardware support to connect with an external storage device such as hard drive and pen drive and to connect with a network. Thus, the server enables all client devices in the home network to stream same or different recorded content and store computer generated copied content from internal or external hard drive of the server. Further, the server can stream content to all the client devices based on network bandwidth. Additionally, the user can access contents stored at server and play as per their requirement on any of the client devices.

However, during the viewing, the user is unable to mark a portion of the content for future viewing or sharing or recommending. For this, the user has to remember file name of the content, start time of the portion in the content, end time of the portion in the content, and duration of the portion in the content. Thus, the user has to start playing the content on a media playing application and forward a progress bar of the media playing application to start time of the portion in the content for viewing or sharing. This process is tedious and time-consuming leading to poor user experience.

Various solutions are available that enable the user to mark of a portion of a content for future viewing or sharing or recommending. In one solution, a media sharing application allows a user to add a small bit of code to a link of a media content being played through the media sharing application. The small bit of code is essentially eight characters in length to enable the user to indicate a start time corresponding to the portion of the media content. The user then shares the modified link with a second user via comments or email or messaging applications. Alternatively, the media sharing application enables the user to indicate the start time through comments on the media content. Upon receiving the comments or the modified link, the second user accesses the modified link. Upon accessing the modified link, the media sharing application forwards a progress bar to the start time and renders the portion of the content from the start time. However, this solution does not provide an end time of the portion and therefore does not provide flexibility to the user in terms selectively providing a start time and an end time. In addition, the user manually creates the modified link and shares the modified link. However, the modified links are not stored either locally or at remote location for enabling viewing, sharing, or recommending in future.

In another solution, portions of audio/video data files can be shared with different users of a social networking system. Accordingly, a user divides an audio/video data file into portions based on different contents of the audio/video data file and assigns each portion with a predefined tag such that each predefined tag includes an associated portion of the audio/video data file. The user also defines rules for each predefined tag for sharing the associated portion of the audio/video data file. The rules are stored as metadata comprised by the audio/video data file. The rules can be location based, person based, time based, summary based, availability based, age based, and video navigation based. Thereafter, the user shares the predefined tags with other users of the social networking system. When the other user elects to access the audio/video data file, the rules are retrieved and associated with the other user. Based on the rules, the associated portion of the audio/video data file comprised by the predefined tag is presented to or downloaded by the other user. However, this solution necessitates creation of separate files comprising of specific portions of original audio/video files and sharing of those files, thereby consuming resources such as memory and bandwidth.

In yet another solution, a recorded video content can be rendered for display, and an annotation input can be received that is associated with a displayed segment of the recorded video content. The annotation inputs can be received to include display content, display position data associated with the display content, and a display time that indicates display duration of the display content. The annotation input can be synchronized with synchronization data that corresponds to the displayed segment of the recorded video content. For example, video mark-up application synchronizes each annotation input with video stream embedded timing and/or position synchronization data to associate an annotation input with a specific frame, sequence of frames, and/or segment of the recorded video content. Upon synchronization, a video mark-up data file can be generated that includes the annotation input, the synchronization data, and a reference to the recorded video content. The video mark-up data file are stored at content distributor or storage service provider such that the video mark-up data file can be requested along with on-demand request for the original recorded video content. The stored video mark-up data files are uploaded and shareable among users and subscribers in a media content distribution system. In addition, other users can append additional annotation inputs to the video mark-up data file to create a collaborative video mark-up data file.

However, the annotated mark-up is directly associated with displayed segment of the recorded video content. This necessitates playing the parent-recorded video for accessing or requesting the annotated mark-up. Further, this solution necessitates synchronization between video mark-up annotation input data and parent recorded video data while displaying. In addition, the video mark-up data file cannot be accessed individually as the video mark-up data file can be requested along with on-demand request for the original recorded video content.

As can be gathered from above, the above-mentioned solutions do not provide much flexibility in terms of enabling the user to select a specific portion of media file. In addition, the above solutions involve lot of manual input and necessitate creation of separate files of same files in accordance with selected portions. Therefore, these solutions are resource intensive such as memory and bandwidth.

### SUMMARY

Example embodiments of the present disclosure address the above disadvantages among other things

According to an example embodiment, the present disclosure is purposed to provide a method for creating a shortcut to a content on a specific portion of a content and accessing to the shortcut to access the specific portion and a system thereof. The system includes an electronic device and a server device.

According to an example embodiment, an electronic device includes a display, a communicator configured to communicate with a server, and a processor configured to obtain information on a start point and an end point to create a shortcut file of a portion of a content displayed on the display according to a user input and transmit the information to the server through the communicator, and in response to the content being selected according to a user input, receive, from the server, information on a shortcut file on a portion of the content created based on information on the start point and the end point and a pre-stored different shortcut file relating to the content, and provide the information to the display.

In order to achieve the aforementioned purpose, according to an exemplary embodiment, a method for controlling an electronic device includes obtaining information with respect to a start point and an end point to create a shortcut file of a portion of a content displayed on a display according to a user input, transmitting the obtained information to a server device through a communicator; and in response to the content being selected according to a user input, receiving, from the server device, information regarding a shortcut file with respect to a portion of the content and information regarding a pre-stored different shortcut file with respect to the content based on information regarding the start point and the end point and providing the shortcut file and the different shortcut file to the display.

In order to achieve the aforementioned purpose, according to an exemplary embodiment, a method for controlling a shortcut file of a content from a server device includes receiving, from an electronic apparatus, a request for a start point and an end point of a portion of a content, creating a shortcut file on the portion of the content based on the start point and the end point and storing the shortcut file in database; and in response to a request for reproduction on the content being received from the electronic apparatus, transmitting information on the created shortcut file and a pre-stored different shortcut file relating to the content.

### BRIEF DESCRIPTION OF THE DRAWINGS

The above and/or other aspects of the present disclosure will be more apparent from the following detailed description, taken in conjunction with the accompanying drawings, in which like reference numerals refer to like elements, and wherein:

FIG. 1 illustrates a system for creating a shortcut to a portion of a multimedia document and for accessing the portion of the multimedia document, in accordance with various embodiments of present disclosure.

FIG. 2 schematically illustrates an exemplary networked environment that implements a system or a server for creating a shortcut to a portion of a multimedia document and for accessing the portion of the multimedia document, in accordance with an embodiment of the present disclosure.

FIG. 3 illustrates an example of a shortcut file including both primary attributes and the secondary attributes, in accordance with an embodiment of present disclosure.

FIG. 4 illustrates another example of a shortcut file including the primary attributes, in accordance with an embodiment of present disclosure.

FIG. 5 illustrates an example of displaying the shortcut file on a client device, in accordance with an embodiment of present disclosure.

FIG. 6 illustrates an example of editing the shortcut file on a client device, in accordance with an embodiment of present disclosure.

FIG. 7 illustrates an example of synchronizing a shortcut file, in accordance with an embodiment of present disclosure.

FIG. 8 illustrates an example of creating a shortcut file for a playlist on a client device, in accordance with an embodiment of present disclosure.

FIG. 9 illustrates another example of creating a shortcut file for a playlist on a client device, in accordance with an embodiment of present disclosure.

FIG. 10 illustrates an exemplary method for creating a shortcut to a portion of a multimedia document, in accordance with an embodiment of present disclosure.

FIG. 11 illustrates a first exemplary method for accessing a portion of a multimedia document from the shortcut file, in accordance with an embodiment of present disclosure.

FIG. 12 illustrates a second exemplary method for accessing a portion of a multimedia document from the shortcut file, in accordance with an embodiment of present disclosure.

FIG. 13 illustrates a hardware configuration of an electronic device, in accordance with an embodiment of present disclosure.

### DETAILED DESCRIPTION

Before describing the example embodiments in detail, the terminology used herein will be briefly explained.

The terms used herein are selected from the general terms that are widely used at present and in consideration of the functions in the present disclosure, but at the same time, the terms may vary depending on the intent of those skilled in the art or the precedents, or by the emergence of new technologies. Further, certain terms may be arbitrarily chosen, in which case the corresponding meaning will be described in detail in the disclosure. Accordingly, the terms used herein will be defined not simply based on the names of the terms, but based on the meanings of the terms and the context throughout the description.

The example embodiments of the present disclosure may have a variety of modifications and several examples. Accordingly, while various example embodiments are described in detail herein, these are not intended to limit the scope of the present disclosure to the particular example embodiments only. Rather, it should be understood that the example embodiments encompass all the modifications, equivalents or replacements that fall under the concept and technology scope as disclosed. In describing the example embodiments, well-known functions or constructions may not be described in detail when they obscure the disclosure with unnecessary detail. Further, the terms described below are those that are defined in consideration of the functions of the present disclosure and may be varied according to users, operators or practices. Accordingly, definitions will have to be made based on the content provided throughout the description.

The terms such as “first,” “second,” and so on may be used to describe a variety of elements, but the elements should not be limited by these terms. The terms are used only for the purpose of distinguishing one element from another.

A singular expression includes a plural expression, unless otherwise specified. It is to be understood that the terms such as “comprise” or “consist of” are used herein to designate a presence of characteristic, number, step, operation, element, component, or a combination thereof, and not to preclude a presence or a possibility of adding one or more of other characteristics, numbers, steps, operations, elements, components or a combination thereof.

In the example embodiments of the present disclosure, a ‘module’ or a ‘unit’ may perform at least one function or operation, and be implemented as hardware (e.g., circuitry) or software, or as a combination of hardware and software. Further, except for the ‘module’ or the ‘unit’ that has to be implemented as particular hardware (e.g., a dedicated processor), a plurality of ‘modules’ or a plurality of ‘units’ may be integrated into at least one module and implemented as at least one processor (not illustrated).

In the example embodiments of the present disclosure, when a certain portion is “coupled” with another portion, this means not only the “direct coupling”, but also “electrical coupling” and may be accomplished with intervention of another device interposed there between. Further, when a certain portion “comprises” a certain element, unless otherwise specified, this means that the certain portion may additionally include another element, rather than precluding another element.

The present disclosure will be described in greater detail below with reference to the accompanying drawings to enable those skilled in the art to work the present disclosure with ease. However, the present disclosure may be implemented as several different forms and not to be limited to any of specific examples described herein. Further, in order to clearly describe the present disclosure in the drawings, portions irrelevant to the description may be omitted, and throughout the description, the like elements are given the similar reference numerals.

In accordance with the purposes of the disclosure, the present disclosure as embodied and broadly described herein, provides a methods and systems for creating content shortcut for specific portion of the content and correspondingly access the shortcut to access specific portion. Accordingly, in one embodiment, a first electronic apparatus (“a first electronic device”) receives a request for creating a shortcut to a portion of a multimedia document from a user. The multimedia document may be stored at a location forming part of a first electronic apparatus or at a location forming part of a networked environment. The portion of the multimedia document is identified by a start point and an end point. Upon receiving a request, a shortcut file is created such that the shortcut file includes primary attributes comprising of “path” information and “seek” information corresponding to the portion of the multimedia document. The “path” information identifies a location of the multimedia document and the “seek” information identifies the portion of the multimedia document on basis of the start point and end point.

Further, upon detecting a change in the location of storing of the multimedia document, the “path” information in the shortcut is automatically updated. Additionally, a security setting can be stored in the shortcut file. The security setting defines a level of access to the portion of multimedia document corresponding to the shortcut file.

Further, a recommendation message pertaining to the shortcut files can be sent to other devices in networked environment. As such, the shortcut files along with name of the shortcut files are presented in the form of a user selectable item on a graphical display device.

Further, for accessing the portion of the multimedia document, in one embodiment, a selection on a shortcut file is received. Upon receiving, “path” information and “seek” information are obtained from the shortcut file. Thereafter, the portion of the multimedia document as identified by the “path” information and “seek” information is accessed.

The advantages of the disclosure include, but are not limited to, creating shortcut file for a portion of the media document. The shortcut file only includes attributes such as path information and seek information. This eliminates the need for creation of small portions of media document, which consume space and bandwidth. The shortcut file is saved in a database and can be accessed locally or through network, thus making easier for sharing the shortcut file instead of sharing the small portions of media document.

Further, flexibility in terms of enabling a selection not only start time of the portion of the media document but also end time of the portion of the media document is provided to the user. Thus, the shortcut files enable direct rendering of the portion of the media document. This ensures that other users can view only specific portion and not remaining portion of the media document after the specific portion is over. Further, the shortcut files include the start time and end time of the media document. This enables the user to change the start time and end time, as desired, without creating new shortcut files, thereby providing flexibility and improving user experience. In addition, no synchronization of content is required between the shortcut file and the media document as the shortcut file only includes location of the media document and not actual content of the media document. Thus, any changes in the content of the media document will not require updating of the shortcut file in contrast to the separate files comprising of small portions of media document.

In addition, all the shortcut files including links to the location of the media documents are managed centrally even if the shortcut files and the corresponding media documents are available at different locations. This provides a better user-experience as the user does not have to remember the location. Further, the location of the media documents is updated automatically in the shortcut file when the location of media document is changed. This eliminates needs for manual updating of the shortcut file. Additionally, the shortcut files are treated as separate media documents and are recommended to users when the users are accessing the media document. Moreover, the shortcut files can be played individually without playing the media document. This results in a better user experience.

Further security settings are associated with the shortcut files and not with multimedia documents. Thus, users can access the multimedia documents irrespective of access restrictions on the shortcut files.

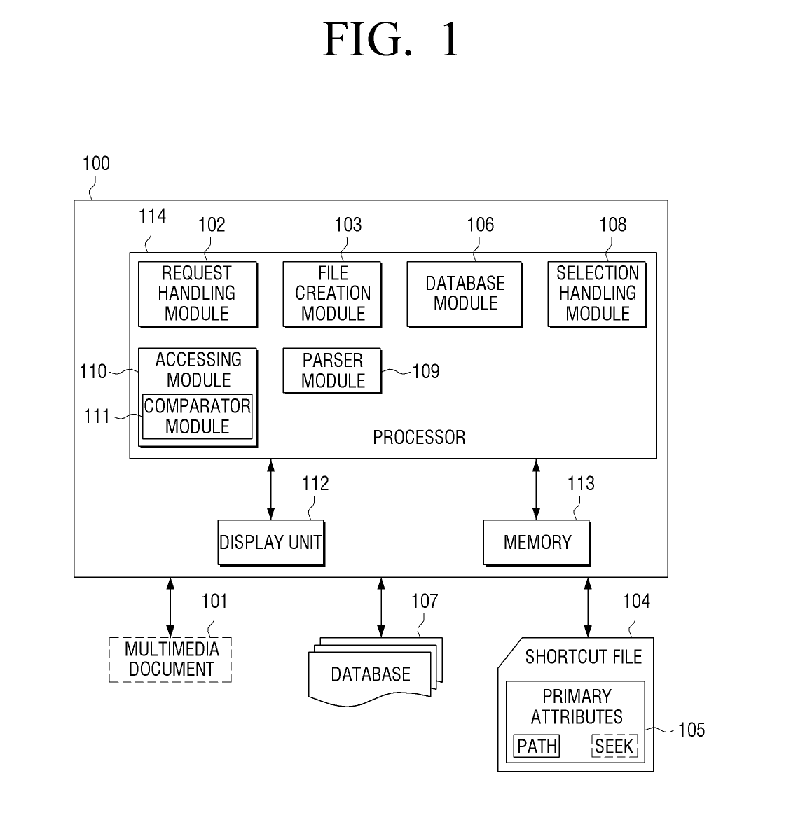

FIG. 1 illustrates a system for creating a shortcut to a portion of a multimedia document and for accessing the portion of the multimedia document, in accordance with various embodiments of present disclosure.

Referring to FIG. 1, the multimedia document (101) is stored at a location forming part of a first device or at a location forming part of a networked environment. Examples of the multimedia document (101) include, but not limited to, video, audio, animation, image, and a combination thereof. The multimedia document (101) can be rendered or streamed via media rendering/playing application available on the first device. Examples of the first device include, but not limited to, network hard drives (NAS), smart phone, laptop, tablet, and desktop personal computer (PC). Further, in an example, the networked environment is a Digital Living Network Alliance (DLNA) compliant home network. In such example, the location can be any device compliant with DLNA such as network hard drives (NAS), smart phone, laptop, tablet, and desktop personal computer (PC). In addition, the system (100) can be a DLNA compliant digital media server (DMS).

As such, in accordance with one embodiment, the system (100) includes a request handling module (102) for receiving a request for creating a shortcut to a portion of the multimedia document (101). The portion of the multimedia document (101) is identified by a start point and an end point. The system (100) further includes a file creation module (103) for creating a shortcut file (104) based on the request such that the shortcut file (104) includes primary attributes (105). The primary attributes (105) includes “path” information and “seek” information. The “path” information identifies a location of the multimedia document (101) and the “seek” information identifies the portion of the multimedia document (101) on basis of the start point and the end point.

In accordance with another embodiment for creating the shortcut file, the file creation module (103) creates the shortcut file (104) such that the shortcut file (104) includes only the “path” information identifying the location of the multimedia document (101). Further, the system (100) includes a database module (106) for creating an entry associated with the shortcut file (104) in a database (107). The entry associated with the shortcut file (104) includes the primary attributes (105) corresponding to the shortcut file (104). The primary attributes (105) includes “path” information identifying location of the multimedia document (101) and “seek” information identifying the portion of the multimedia document (101) on basis of the start point and the end point.

Further, according to the present disclosure, the system (100) implements method for accessing the portion of the multimedia document (101). As such, in accordance one embodiment, the system (100) includes a selection handling module (108) for receiving a selection of the shortcut file (104). The system (100) further includes a parser module (109) for obtaining “path” information and a “seek” information from the shortcut file (104). The “path” information identifies a location of the multimedia document (101) and the “seek” information identifies the portion of the multimedia document (101) on basis of the start point and end point. The system (100) further includes an accessing module (110) for accessing the portion of the multimedia document (101) as identified by the “path” information and “seek” information.

Further, the parser module (109) is adapted to obtain “path” information corresponding to the shortcut file (104) from the database (107). Further, the accessing module (110) includes a comparator module (111) for comparing the “path” information as obtained from the shortcut file (104) with the “path” information as obtained from the predetermined database (107). Upon receiving an output from the comparator module (111) indicating a mismatch between the “path” information as obtained from the shortcut file (104) and the “path” information as obtained from the predetermined database (107), the accessing module (110) is further adapted for accessing the portion of the multimedia document (101) as identified by the “path” information obtained from the predetermined database (107).

In accordance with another embodiment for accessing the portion of the multimedia document, the parser module (109) obtains “path” information identifying a location of the multimedia document (101) from the shortcut file (104). The database module (106) is adapted for obtaining “seek” information from the database (107) that includes an entry corresponding to the shortcut file (104). The “seek” information identifies the portion of the multimedia document (101) on basis of the start point and end point. Further, the accessing module (110) is adapted for accessing the portion of the multimedia document (101) as identified by the “path” information and “seek” information.

Further, the parser module (109) is adapted to obtain “path” information corresponding to the shortcut file (104) from the database (107). The comparator module (111) then compares the “path” information as obtained from the shortcut file (104) with the “path” information as obtained from the database (107). The accessing module (110) is then adapted for accessing the portion of the multimedia document (101) as identified by the “path” information obtained from the database (107), upon receiving an output from the comparator module (111) indicating a mismatch between the “path” information as obtained from the shortcut file (104) and the “path” information as obtained from the database (107).

Further, the system (100) includes display unit (112) adapted to display various elements such as images, texts, and videos. The system (100) also includes a memory (113) coupled to the above-mentioned modules. The system (100) also includes a processor (114) adapted to perform necessary functions of the system (100) and to control the functions of the above-mentioned modules of the system (100).

It would be understood that the system (100) and the processor (114) may further include various hardware modules/units/components or software modules or a combination of hardware and software modules as necessary for implementing the disclosure.

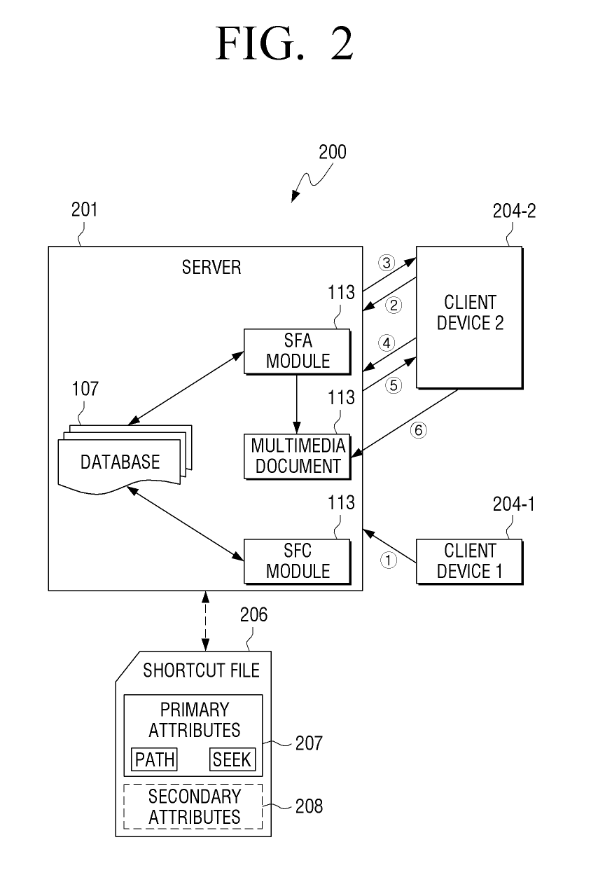

Accordingly, FIG. 2 schematically illustrates an exemplary networked environment that implements a system or a server for creating a shortcut to a portion of a multimedia document and for accessing the portion of the multimedia document, in accordance with an embodiment of the present disclosure.

Referring to FIG. 2, the server (201) includes modules and units as described in reference to FIG. 1. For the sake of brevity and ease of understanding, the server (201) includes a shortcut file creation (SFC) module (202) and a shortcut file access (SFA) module (203). The SFC module (202) includes the request handling module (102), the file creation module (103), and the database module (106) as illustrated in FIG. 1. The SFA module (203) includes the selection handling module (108), the parser module (109), the accessing module (110), and the comparator module (111) as illustrated in FIG. 1. In one aspect of the disclosure, the SFC module (202) and the SFA module (203) are implemented as separate modules as depicted in the figure. In another aspect of the disclosure, the SFC module (202) and the SFA module (203) are implemented as single module. In one another aspect of the disclosure, the SFC module (202) and the SFA module (203) can be implemented as part of an application available or/and installed on the server (201). In such aspect, the application can be either downloaded on to the server (201) or pre-stored in the server (201).

The server (201) is communicatively coupled with a plurality of client devices (204) over a network (not shown in the figure). For the sake of brevity, only two client devices have been illustrated as first client device (204-1) and second client device (204-2). Examples of the network include, but not limited to, data network, voice network, broadcast network, an IP-based network, and a wireless network. The network can be implemented using any type of network topology such as home network, and can be represented or otherwise implemented as a combination of two or more networks. In an example, the network is a Digital Living Network Alliance (DLNA) compliant home network. The client devices (204) are digital media rendering or playing (DMR or DMP) devices, capable of rendering or playing multimedia content. Examples of the client devices (204) include, but not limited to, smart television (TV) with a set top box, smart phone, laptop, tablet, audio system, and desktop personal computer (PC), that are compliant with DLNA.

Further, the server (201) is capable of receiving one or more multimedia documents (205) from a content distributer (not shown in the figure) or from the client devices (204) over a network (not shown in the figure) or external storage device (not shown in the figure) such as hard drive and pen drive. Examples of the multimedia documents (205) include, but not limited to, video content, audio content, animation content with audio, animation content without audio, audio-video content, and images. Various contents provided on a display of the electronic device may be included in a multimedia document. The multimedia documents (205) can be either pre-recorded, streaming, or recorded from streaming media. Further, the server (201) stores the multimedia documents (205) in the memory (113) for later viewing. In an example, the server (201) is a DLNA compliant digital media server (DMS). As would be understood, any device compliant with DLNA and capable of storing multimedia document (205) can be designated as the DMS. Examples of such devices include, but not limited to, network hard drives (NAS), smart phone, laptop, tablet, and desktop personal computer (PC).

In operation, a user can access the multimedia document (205) from the server (201) via a media rendering/playing application available on the first client device (204-1). In an example, the multimedia document (205) is a movie having a total duration of 2 hours 23 minutes and 53 seconds and accessed from the server (201). The user can provide a request for creating a shortcut to a portion of the multimedia document (205). Consequently, the user can provide the request in two portions indicating selection of portion of the multimedia document (205). As such, a start request can be provided for selecting ‘start point’ of the portion of the multimedia document (205). In one aspect of the disclosure, the start point of a multimedia document can be a time selected in a video content, audio content, and animation content. In another aspect of the disclosure, the start point of a multimedia document can be an image selected from a plurality of images. In one example, the user can provide the start request via a predefined key on a remote controller. In another example, the user can provide the start request via audio input. In one another example, the user can provide the start request via a touch based gesture input.

Accordingly, the first client device (205-1) provides the start request to the SFC module (202). In an example, a shortcut request initiator module (not shown in the figure) in the first client device (205-1) sends the start request to the SFC module (202). Upon receiving the start request, the SFC module (202) identifies a start point of the portion of the multimedia document (205). In the above example, the user sends the start request at 0 hour 53 minutes and 23 seconds of the movie. Accordingly, the SFC module (202) identifies the start point of the portion of the movie as time starting from 0 hour 53 minutes and 23 seconds.

Thereafter, the user can provide a stop request for selecting ‘end point’ of the portion of the multimedia document (205). In one aspect of the disclosure, the end point of a multimedia document can be time selected in a video content, audio content, and animation content. In another aspect of the disclosure, the end point of a multimedia document can be an image selected from a plurality of images. In one example, the user can provide the stop request via a predefined key on a remote controller. In another example, the user can provide the stop request via audio input. In one another example, the user can provide the stop request via a touch based gesture input.

Accordingly, the first client device (205-1) provides the stop request to the SFC module (202). In an example, the shortcut request initiator module in the first client device (205-1) sends the stop request to the SFC module (202). Upon receiving the stop request, the SFC module (202) identifies an end point of the portion of the multimedia document (205). In the above example, the user sends the stop request at 1 hour 13 minutes and 53 seconds of the movie. Accordingly, the SFC module (202) identifies the end point of the portion of the movie as time ending at 1 hour 13 minutes and 53 seconds. The start request and the stop request indicate the request for creating a shortcut to the portion of the multimedia document (205). The request from the first client device (205-1) to the server (201) is illustrated by arrow (1).

In another aspect of the disclosure, if the user does not provide the stop request within a predetermined time period from the start request, the SFC module (202) identifies the predetermined time period as the end point. In an example, the time period is predetermined by the user during initial configuration settings of the networked environment (200). In the above, the predetermined time period is 10 minutes from the start request. If the end request is not required within or by expiry of 10 minutes, the SFC module (202) identifies the end point of the portion of the movie as time ending at 1 hour 3 minutes and 23 seconds.

Upon receiving the start point and the end point, the SFC module (202) determines duration of the portion of the multimedia document (205) based on the start point and end point. In one aspect of the disclosure, the duration of a portion of a multimedia document can be a time period between the start time and the end time selected in a video content, audio content, and animation content. In another aspect of the disclosure, the duration of a portion of a multimedia document can number of images between the starting image and the ending image selected from a plurality of images. In the above example, the start point is “0 hour 53 minutes and 23 seconds” and the end point is “1 hour 13 minutes and 53 seconds”, and therefore the duration is determined as a period of “0 hour 20 minutes and 30 seconds.”

Upon determining the duration, the SFC module (202) creates a shortcut file (206) for the portion of the multimedia document (205). The shortcut file (206) is created using methods known in the art. Thus, the shortcut file (206) only takes a few kilobytes of memory space as the shortcut file (206) does not include actual portion of the multimedia document (205). In addition, the shortcut file (206) is created instantaneously and therefore does not consume lot of network bandwidth.

Further, the SFC module (202) captures information pertaining to the portion of the multimedia document (205) in the shortcut file (206). Accordingly, the shortcut file (206) includes primary attributes (207). The primary attributes includes “path” information and “seek” information. The “path” information identifies a location of the multimedia document (205). In the above example, the location of the multimedia document (205) is the server (201). In such example, the “path” information includes a link to the server (201). The “seek” information identifies the portion of the multimedia document (205) on basis of the start point and end point or the duration of the portion of the multimedia document (205). In the above example, the “seek” information is the time period of “0 hour 20 minutes and 30 seconds.”

Furthermore, the shortcut file (206) may also include secondary attributes (208). The secondary attributes (208) include, but not limited to a name pertaining to the shortcut file (206), a revised name pertaining to the shortcut file (206), a summary, information pertaining to play speed, information pertaining to Black-Out time, information pertaining to a type of player, a time of creation of the shortcut file (206), a time of modification of the shortcut file (206), information pertaining to sharing of the shortcut file (206), and information pertaining to security setting pertaining to the shortcut file (206). The secondary attributes (208) also include an icon or a thumbnail providing a pictorial representation of the shortcut file (206). In an example, the icon or thumbnail represent a media rendering or playing application capable of playing the portion of the multimedia document (205). In another example, the icon or thumbnail represents the either the portion of the multimedia document (205) itself or the multimedia document (205) itself. The secondary attributes (208) also include a display message created by the user.

Upon creation of the shortcut file (206), the SFC module (202) creates an entry in a database (209) corresponding to the shortcut file (206) and information pertaining to the multimedia document (205). As would be understood, the entry provides a mapping relationship between the shortcut file (206) and the corresponding portion of the multimedia document (205). In one aspect, the database (209) is integral part of the server (201) as illustrated in the figure. In another aspect, the database (209) is external part of the server (201). In accordance with the disclosure, the entry includes the primary attributes (207) corresponding to the shortcut file (206).

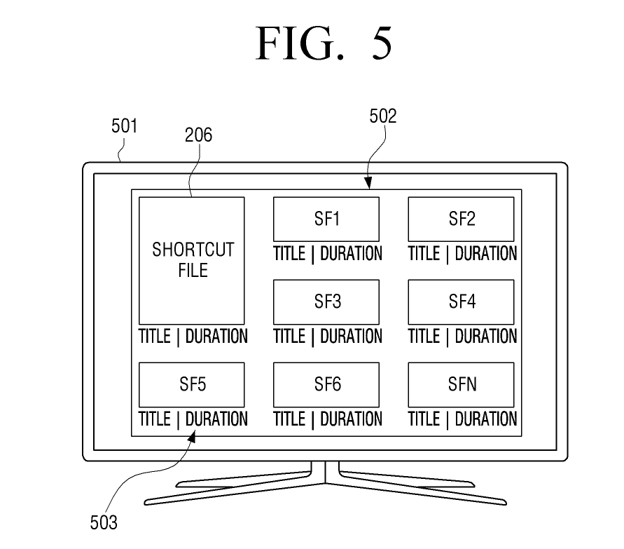

Referring to In addition, a user can access the portion of the multimedia document (205) corresponding to the shortcut file (206) from the second client device (204-2). Accordingly, the user can view one or more shortcut files, including the shortcut file (206) on the second client device (204-2), as described in reference to FIG. 5 above. The user can provide a request for accessing the portion of the multimedia document (205) by selecting the shortcut file (206). In one example, the user can provide the request via a predefined key on a remote controller. In another example, the user can provide the start request via audio input. In one another example, the user can provide the stop request via a touch based gesture input. In one aspect of the disclosure, the second client device (204-2) is dependent on the server (201) for providing the multimedia document (205). Accordingly, the second client device (204-2) provides the request to the SFA module (203). In an example, a shortcut request initiator module (not shown in the figure) in the second client device (205-2) sends the access request to the SFA module (203). The access request from the second client device (204-2) to the server (201) is illustrated by arrow (2).

Upon receiving the access request, the SFA module (203) fetches the shortcut file (205) and obtains “path” information from the primary attributes of the shortcut file (206). As described earlier, the shortcut file (205) can be saved at the server (201) or at the client device (204). The SFA module (203) also obtains “path” information corresponding to the shortcut file (206) from the database (209). Thereafter, the SFA module (203) compares the “path” information as obtained from the shortcut file (206) with the “path” information as obtained from the database (209).

When the “path” information as obtained from the shortcut file (206) matches with the “path” information as obtained from the database (209), the SFA module (203) fetches the multimedia document (205) from the location as indicated in the “path” information of the shortcut file (206). However, when the “path” information as obtained from the shortcut file (206) does not match with the “path” information as obtained from the database (209), the SFA module (203) fetches the multimedia document (205) from the location as indicated in the “path” information from the database (209).

Upon fetching the multimedia document (205), the SFA module (203) retrieves the portion of the multimedia document (205) from the multimedia document (205) in accordance with the “seek” information of the shortcut file (206). In an example, the SFA module (203) includes a retrieving module configured to retrieve the portion of the multimedia document (205) from the multimedia document (205), in accordance with methods known in the art. The SFA module (203) then transmits the portion of the multimedia document (205) to the second client device (204-2). The transmitting of the portion of the multimedia document (205) from the server (201) to the second client device (204-2) is illustrated by arrow (3). Upon receiving the portion of the multimedia document (205), a media rendering or playing application available on the second client device (204-2) renders or plays the portion of the multimedia document (205). In another aspect of the disclosure, the second client device (204-2) independently obtains the multimedia document (205) from the location of path information. Accordingly, the second client device (204-2) provides the access request to the SFA module (203). In an example, a shortcut request initiator module (not shown in the figure) in the second client device (204-2) sends the access request to the SFA module (203). The access request from the second client device (204-2) to the server (201) is illustrated by arrow (4).

Upon receiving the request, the SFA module (203) obtains “path” information from the primary attributes of the shortcut file (206). The SFA module (203) also obtains “path” information corresponding to the shortcut file (206) from the database (209). Thereafter, the SFA module (203) compares the “path” information as obtained from the shortcut file (206) with the “path” information as obtained from the database (209).

When the “path” information as obtained from the shortcut file (206) matches with the “path” information as obtained from the database (209), the SFA module (203) provides the location as indicated in the “path” information of the shortcut file (206) to the second client device (204-2). However, when the “path” information as obtained from the shortcut file (206) does not match with the “path” information as obtained from the database (209), the SFA module (203) provides the location as indicated in the “path” information from the database (209) to the second client device (204-2). Further, the SFA module (203) provides the “seek” information from the shortcut file (206) to the second client device (204-2). The transmission of location information and ‘seek information’ from the server (201) to the second client device (204-2) is illustrated by arrow (5).

Upon receiving the location information, the second client device (204-2) fetches the multimedia document (205) from the location. In the present example, the multimedia document (205) is saved at the server (201). As such, the second client device (204-2) sends the request for the multimedia document (205) to the server (201). The request for multimedia document (205) from the second client device (204-2) to the server (201) is illustrated by arrow (6).

Upon fetching the multimedia document (205), the second client device (204-2) retrieves the portion of the multimedia document (205) from the multimedia document (205) in accordance with the “seek” information of the shortcut file (206). In an example, the second client device (204-2) includes a retrieving module configured to retrieve the portion of the multimedia document (205) from the multimedia document (205), in accordance with methods known in the art. Upon retrieving the portion of the multimedia document (205), a media rendering or playing application available on the second client device (204-2) renders or plays the portion of the multimedia document (205).

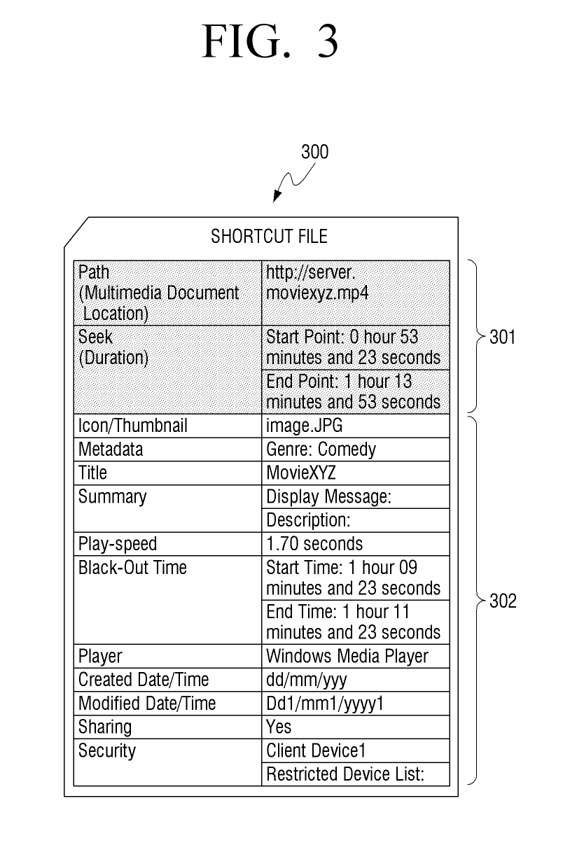

In one aspect of the disclosure, the SFC module (202) creates the shortcut file (206) such that both the primary attributes (207) and the secondary attributes (208) are saved within the shortcut file (206). Accordingly, FIG. 3 illustrates an example of a shortcut file including both primary attributes and the secondary attributes, in accordance with an embodiment of present disclosure. Referring to FIG. 3, the shortcut file (300) is created from the movie titled ‘MovieXYZ’ having a total duration of 2 hours 23 minutes and 53 seconds and accessed from the server (201), as described above. Thus, the primary attributes (301) (highlighted in colour) include ‘path’ information identifying location of the server (201) as http://server.moviexyz.mp4, and ‘seek’ information identifying the ‘start time’ as 0 hour 53 minutes and 23 seconds and ‘end time’ as 1 hour 13 minutes and 53 seconds. Upon creation of the shortcut file (300), the user can edit the start point and the end point. In the present example, the user can increase or decrease either of the start time and the end time.

Further, the secondary attributes (302) may include following details pertaining to the movie:

Icon/Thumbnail: The thumbnail is obtained by fetching corresponding thumbnail of movie from the server (201). In the present example, the thumbnail is an image.

Metadata: The metadata is obtained by fetching corresponding metadata of movie from the server (201). In the present example, the metadata includes ‘genre’ of the movie as ‘comedy’.

Title or Name: The title is obtained by fetching corresponding title of movie from the server (201). In the present example, the title is saved as ‘MovieXYZ’.

Summary: The summary can include a ‘display message’ and a ‘description’. The ‘display message’ can be text entered by the user at the time of sending a request for creation of the shortcut file (300). In an example, the server (601) prompts the user for the ‘display message’. The ‘description’ can be short description provided by a content distributor or content creator corresponding to the movie. The description can be obtained by fetching corresponding metadata of movie from the server (201).

Play speed: The play speed indicates a speed at which the movie will be played. The user can edit the play speed. In the present example, the play speed is 1.70 seconds.

Blackout time: The black-out time is a portion within the selected duration of the movie that user wants to block from viewing. The server (201), during rendering of the portion of the movie, will skip the portion falling within the blackout time. In the present example, the duration is from 0 hour 53 minutes and 23 to 1 hour 13 minutes and 53 seconds. The user can set blackout time from 1 hour 09 minutes and 23 seconds as ‘start time’ to 1 hour 11 minutes and 23 seconds as ‘end time’. Thus, when the server (201) plays the movie from 0 hour 53 minutes and 23, the portion corresponding to 1 hour 09 minutes and 23 seconds till 1 hour 11 minutes and 23 seconds will be skipped or shown as ‘blank screen’.

Player: The player indicates one or more media rendering or playing applications suitable for playing the movie. In the present example, the player is Windows Media Player™.

Created Date/Time and Modified Date/Time: The date/time of creation and modification are indicated.

Sharing: The sharing indicates whether the shortcut file (300) is selected by the user for sharing across the client devices (204) coupled with the server (201). In the present example, the user has selected the shortcut file (300) for sharing (Yes).

Security: The security can include a ‘device name’ through which the shortcut file (300) was created and a ‘list of other devices’ to which the user has restricted from accessing the portion of the movie corresponding to the shortcut file (300). In the present example, the user has created the shortcut file (300) through first client device (′Client Device 1′) and has not restricted any other device from accessing the portion of the movie corresponding to the shortcut file (300).

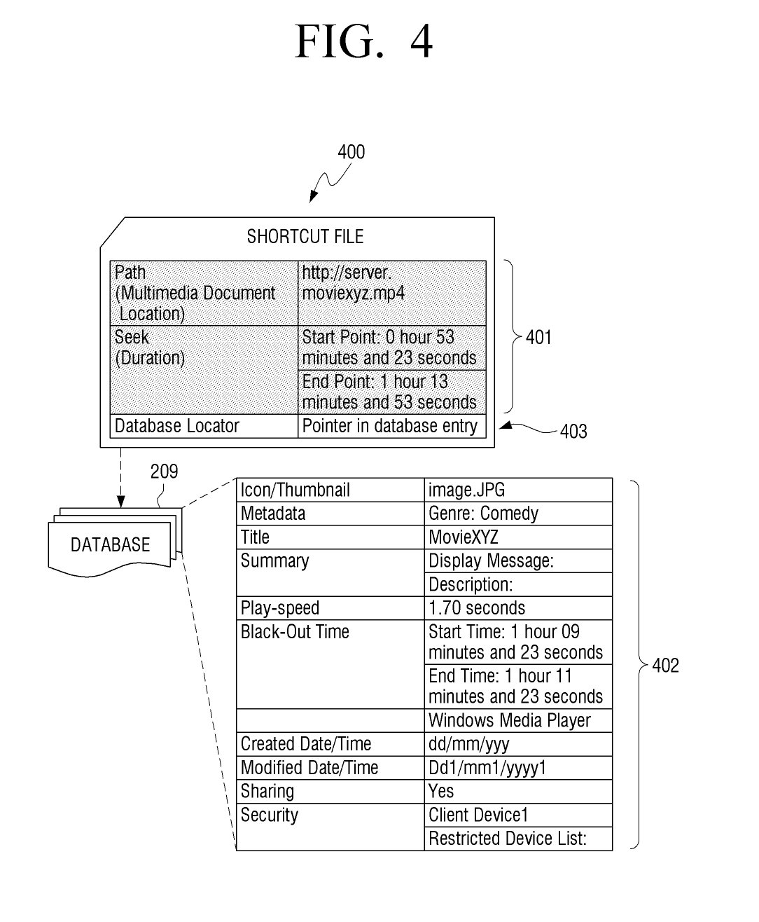

In another aspect of the disclosure, the SFC module (202) creates the shortcut file (206) such that the primary attributes (207) are saved within the shortcut file (206) and the secondary attributes (208) are saved in the database (209). Accordingly, FIG. 4 illustrates another example of a shortcut file including the primary attributes, in accordance with an embodiment of present disclosure. The secondary attributes (402) are saved in the database (209) by the SFC module (202) illustrated in FIG. 2. Accordingly, the shortcut file (400) includes a primary attributes (401) and also includes a database locator (403) indicating a location of entry in the database (209) corresponding to the secondary attributes. The shortcut file (400) is created from the movie titled ‘MovieXYZ’ having a total duration of 2 hours 23 minutes and 53 seconds and accessed from the server (201), as described above. The shortcut file (400) includes the same attributes and values as in the shortcut file (300) illustrated in FIG. 3 for the ease of understanding.

Upon creation of the entry, the SFC module (202) saves the shortcut file (206). In one aspect of the disclosure, the SFC module (202) saves the shortcut file (206) in the server (201). In another aspect of the disclosure, the SFC module (202) saves the shortcut file (206) in one of the client devices (204). In yet another aspect of the disclosure, the SFC module (202) saves the shortcut file (206) at remote location, such as a cloud based server.

Upon saving the shortcut file (206), the SFC module (202) displays the shortcut file (206) on the client device (204) via a user-interface as a user selectable item. The shortcut file (206) is treated as a separate newly added multimedia document and is displayed along with the multimedia documents (201) on the client devices (204).

Accordingly, FIG. 5 illustrates an example of displaying the shortcut file on a client device, in accordance with an embodiment of present disclosure. Referring to FIG. 5, the client device (501) is part of the plurality of client devices (204) communicatively coupled with the server (201) as illustrated in FIG. 2. The client device (501) provides a user-interface (502) for displaying one or more shortcut files (SF) (503), including the shortcut file (206), as user selectable items. The shortcut files (503) are displayed using the icons or thumbnails saved as the secondary attributes. Further, title or name pertaining the shortcut files (503) and duration of the shortcut files (503), saved as the secondary attributes, are also displayed along with the icons or thumbnails of the shortcut files (503). This enables the user to browse the shortcut files (503) easily on the user-interface (502).

Further, the SFC module (202) recommends the shortcut files (503) on the client device (204) connected with the server (201) when user on the client device (204) accesses the corresponding multimedia documents. The client device (204) can be a client device through which a request for creation of shortcut file was received or any other client device. In an example, the recommended shortcut files (503) are displayed in separate user interface, placed adjacent to a user-interface rendering or playing the corresponding multimedia document. In another example, the recommended shortcut files (503) are displayed at a strategic location in a user-interface rendering or playing the corresponding multimedia document. Further, the SFC module (202) recommends the shortcut files (503) based on the secondary attributes of the shortcut files (503), such as metadata and title. In an example, a user A has created three short cut files from a video file titled video_1.mp4 through first client device (204-1) and all the short cut files are saved in the server (201). In such example, after some time a user B starts playing the same video file titled video_1.mp4 on either the first client device (204-1) or the second client device (204-2). Consequently, all the three short cut files created previously by the user A will be shown as recommended files by the SFC module (202) for the user B on either the first client device (204-1) or the second client device (204-2).

Upon receiving the recommended shortcut files (503), the user can directly select a shortcut file for rendering or playing on the client device (204). In one example, the user can select a shortcut file via a predefined user manipulation key on a remote controller. In another example, the user can select a shortcut file via audio input. In one another example, the user can select a shortcut file via a touch based gesture input.

Further, upon receiving the recommended shortcut files (503), the user can create new shortcut file from the corresponding multimedia document, as described above. In such case, the SFC module (202) adds the newly created shortcut file in the list of recommended shortcut files (503) for the corresponding multimedia document. In the above example, the user B creates new shortcut files from the video file titled video_1.mp4. The shortcut files including the newly created shortcut files by user B will be shown as recommended files to the user A and user B.

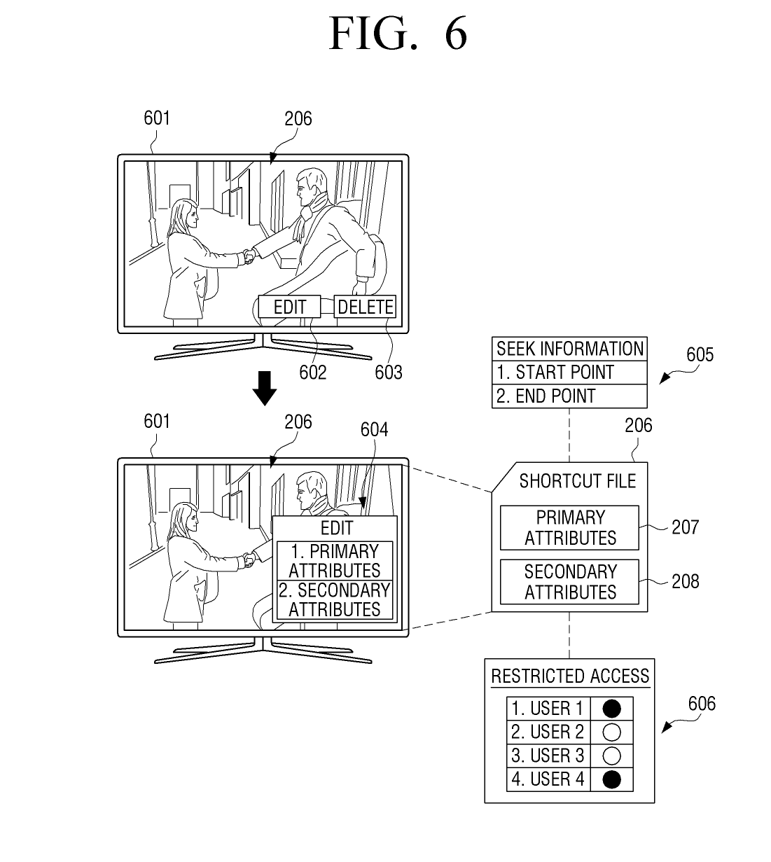

Further, the primary attributes (207) and the secondary attributes (208) of the shortcut file (206) can be edited either locally at the server (201) or at the client device (204) through which the shortcut file (206) was created. Accordingly, FIG. 6 illustrates an example manifestation of editing the shortcut file on a client device, in accordance with an embodiment of present disclosure. Referring to FIG. 6, the client device (601) is part of the plurality of client devices (204) communicatively coupled with the server (201). Upon selecting the shortcut file (206) from a user-interface (as described in reference to FIG. 5 above), a request can be provided to edit the shortcut file (206) on the client device (601). The request for editing can be provided via various options such as hovering input, right click input, gesture input, predefined key input from a remote controller, and audio input. Upon receiving the editing request, the SFC module (202) provides an edit option (602) and a delete option (603) on the user-interface. Upon receiving a selection of the edit option (602) from the user, the SFC module (202) provides a second user-interface (604) on the client device (601). In an example, the second user-interface (604) is overlaid on the previous user-interface. The second user-interface (604) can provide options to edit the primary attributes (207) and the secondary attributes (208).

Upon receiving a selection of the option to edit the primary attributes (207) from the user, the SFC module (202) provides a third user-interface (605) on the client device (601). The third user-interface (605) provides options to edit the ‘seek’ information, i.e., the start point and the end point of the shortcut file (206). As such, the user can increase or decrease either of the start point and the end point. Referring to the example of the shortcut file created from the movie, the start time saved the shortcut file can be increased or decreased. Similarly, the end time saved the shortcut file can be increased or decreased. Thus, the user can easily update an existing shortcut file without having to create a new shortcut file. This provides flexibility and ease of use to the user and results in better user-experience.

Similarly, upon receiving a selection of the option to edit the secondary options (208) from the user, the SFC module (202) provides a fourth user-interface (not shown in the figure) on the client device (601). The fourth user-interface provides options to edit, but not limited to, title or name pertaining to the shortcut file (206), edit a message corresponding to the shortcut file (206), and edit security options corresponding to the shortcut file (206).

Upon receiving a selection of the option to edit security options from the user, the SFC module (202) provides a fifth user-interface (606) on the client device (601). The fifth user-interface (606) provides options to restrict one or more users from accessing the shortcut file (206). In an example, access is restricted to a video file titled parent.mp4 at the server (201). There are three users, user A, user B, and user C, present in the networked environment accessing contents from the server (201) through the first client device (204-1), the second client device (204-2), and a third client device (not shown in the figure). Further, user A and user B have permission to access the video file titled parent.mp4. In such example, user B creates two shortcut files from the video file titled parent.mp4 and grants permission to user C for accessing the short cut file. However, user B restricts access of the shortcut file to user A. As would be understood, the user A is restricting access to the shortcut files by the respective client devices. After some time, when user A access the video file titled parent.mp4 through the first client device (204-1), all the short cut files previously created by user B will be shown as recommended files. However, when the user A selects any of the recommended shortcut files for playing, a pop up message will be displayed on the first client device (204-1) indicating information about restricted access. As would be understood, the server (201) restricts the access by determining which client device has requested the access. In an example, details of the client device are available in the request.

Upon receiving inputs from the user through the ‘edit’ option (602), the SFC module (202) updates corresponding attributes in the shortcut file (206) or in the database (209). Similarly, upon receiving selection of the ‘delete’ option (603) from the user, the SFC module (202) deletes the shortcut file (206) and corresponding entry in the database (209).

Further, the shortcut file (206) and corresponding entry in the database (209) are auto synchronized by the SFC module (202) when a location of the multimedia document (205) is changed. Thus, the “path” information in the primary attributes (207) of the shortcut file (206) are automatically updated to the new location of the multimedia document (205).

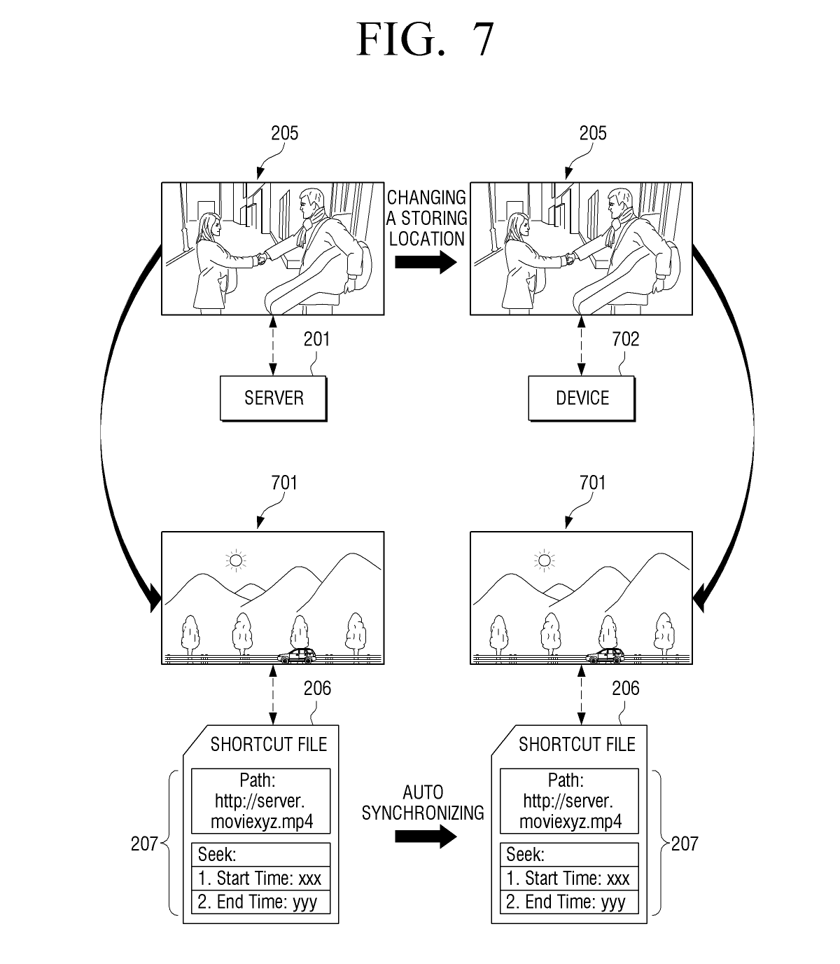

Accordingly, FIG. 7 illustrates an example of synchronizing a shortcut file, in accordance with an embodiment of present disclosure. The shortcut file (206) is created from the multimedia document (205) stored at the server (201), as described earlier. In an example, the multimedia document (205) is a movie titled ‘MovieXYZ’ having a total duration of 2 hours 23 minutes and 53 seconds. The primary attributes (207) include ‘path’ information identifying location of the server (201) as http://server.moviexyz.mp4, and ‘seek’ information identifying the ‘start time’ as xxx and ‘end time’ as yyy. The shortcut file (206) is depicted via a thumbnail (701), obtained from the multimedia document (205).

The user can change the location of the multimedia document (205) from the server (201) to device (702) capable of storing the multimedia document (205). The device (702) is part of the networked environment (200) and is communicatively coupled with the server (201) via the network. Examples of the device (205) include a second server similar to server (201) and the client device (204). The user can change the location using methods known in the art.

Upon changing the location of the multimedia document (205), the SFC module (202) auto-synchronizes the shortcut file (206) such that the ‘path’ information identifies the new location of the multimedia document (205). The SFC module (202) auto-synchronizes the shortcut file (206) using methods known in the art. Accordingly, the SFC module (202) updates the ‘path’ information identifying location of the device (702) as http://device. moviexyz.mp4 in the shortcut file (206). Thus, need for creating separate shortcut files or updating shortcut file (206) is eliminated. In addition, user experience is improved as manual interaction for updating the shortcut file (206) is eliminated.

Further, a shortcut file can be created for representing a playlist. In one aspect of the disclosure, the playlist can include a series of shortcut files. In another aspect of the disclosure, the playlist can include a series of multimedia documents (205). In such aspect, the multimedia documents (205) can be images. The shortcut file for representing the playlist can be defined either locally at the server (201) or at the client device (204). Accordingly, the user can select each of the shortcut files or the multimedia documents (205) on the server (201) or on the client device (204). Upon receiving such selection, the SFC module (202) creates a circular queue in a new shortcut file that stores the selected shortcut files or the multimedia documents (205) in order of selection. Thus, when the user accesses the new shortcut file, a slide show comprising of the selected shortcut files or the multimedia documents (205) is displayed. The slideshow will play the portion of the multimedia documents corresponding to the shortcut files or the multimedia documents (205) in order of their selection and according to play speed of each of the multimedia documents.

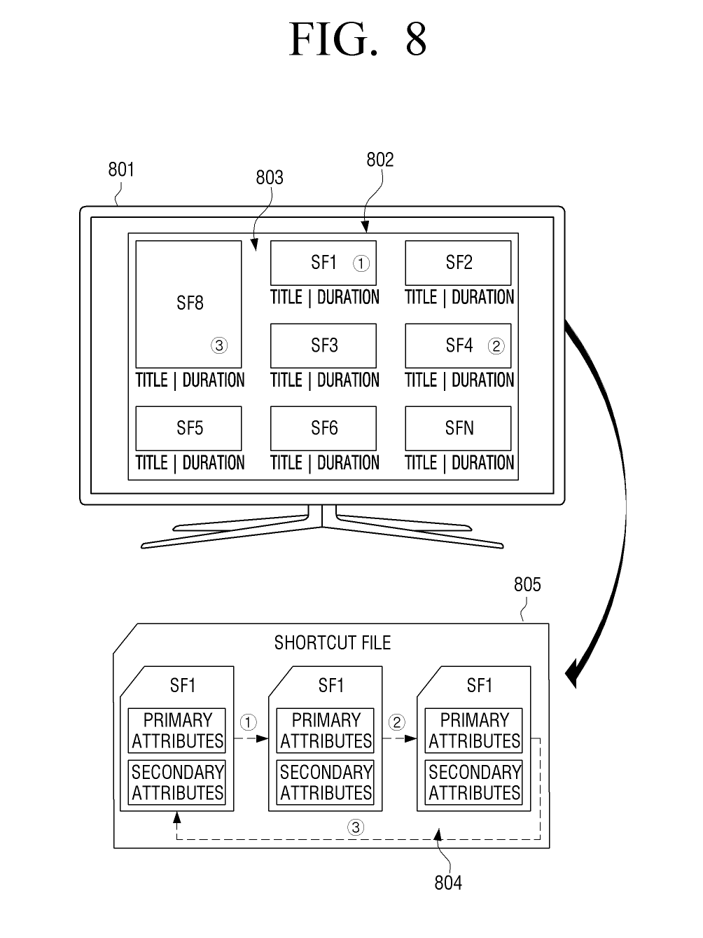

Accordingly, FIG. 8 illustrates an example of creating a shortcut file for a playlist on a client device, in accordance with an embodiment of present disclosure. The playlist includes a series of shortcut files (SF1, SF2, SF3, SF4, SF5, SF6, SF7, SF8). The client device (801) is part of the plurality of client devices (204) communicatively coupled with the server (201) as illustrated in FIG. 2. The client device (801) provides a user-interface (802) for displaying a plurality of shortcut files (SF) (803). The shortcut files (803) are displayed using the icons or thumbnails saved as the secondary attributes. For the sake of brevity, only 8 shortcut files as SF1, SF2, SF3, SF4, SF5, SF6, SF7, and SF8 are illustrated.

The user can selects SF1, SF4, and SF8 from a plurality of shortcut files (803) displayed on the user-interface (802). The order of selection is depicted via reference numbers 1, 2, and 3, respectively. The request for selection can be provided via various options such as hovering input, right click input, gesture input, predefined key input from a remote controller, and audio input.

Upon receiving the selection, the SFC module (202) creates a circular queue (804) that stores the selected shortcut files SF1, SF4, and SF8 in order of their selection. The circular queue (804) is then stored as a new shortcut file (805). Accordingly, primary attributes and secondary attributes of the shortcut file (805) store primary attributes and secondary attributes of the SF1, SF4, and SF8 in order of their selection. Thus, when the user renders the shortcut file (805), the server (201) access the selected shortcut files SF1, SF4, and SF8 from their location according to the circular queue (804) and renders them according to their play speed.

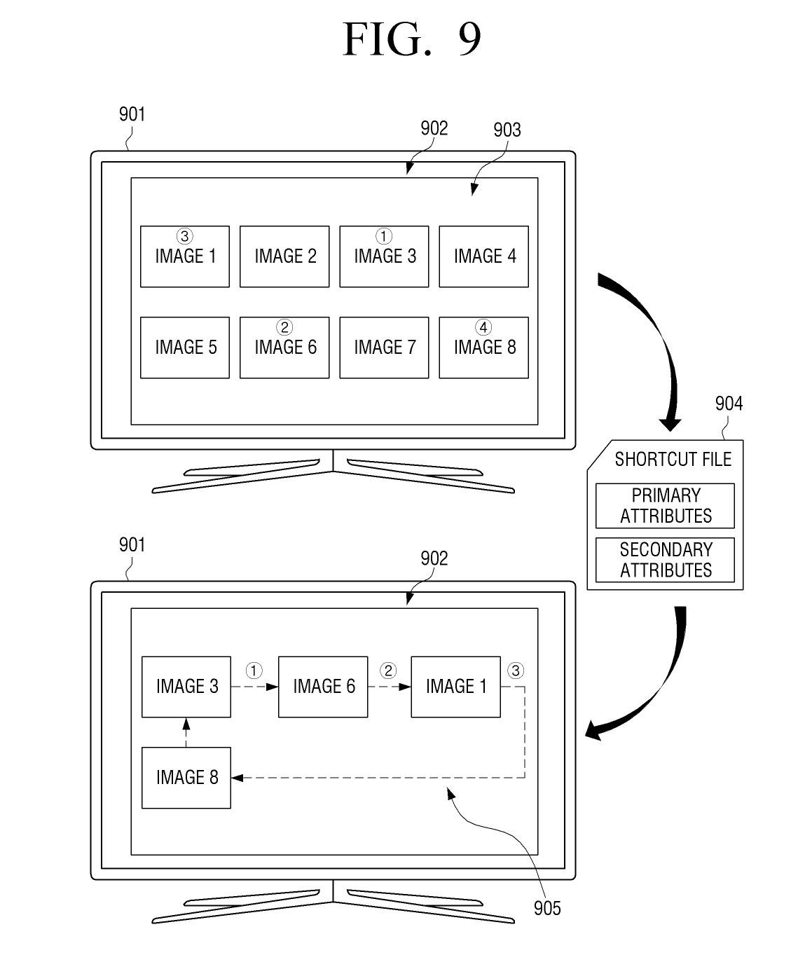

In a similar manner, FIG. 9 illustrates another example of creating a shortcut file for a playlist on a client device, in accordance with an embodiment of present disclosure. The playlist can include a series of images as multimedia documents. The client device (901) is part of the plurality of client devices (204) communicatively coupled with the server (201) as illustrated in FIG. 2. The client device (901) provides a user-interface (902) for displaying a plurality of images (903). For the sake of brevity, only 8 images as Image 1, Image 2, Image 3, Image 4, Image 5, Image 6, Image 7, and Image 8 are illustrated.

The user can selects Image 3, Image 6, Image 1, and Image 8, from the plurality of images (903) displayed on the user-interface (902). The order of selection is depicted via reference numbers 1, 2, 3 and 4, respectively. The request for selection can be provided via various options such as hovering input, right click input, gesture input, predefined key input from a remote controller, and audio input.

Upon receiving the selection, the SFC module (202) creates a new shortcut file (904) such that “path” information in primary attributes of the shortcut file (904) includes location of the selected images in order of their selection. This creates a circular queue (905) storing the location of the images in order of their selection. Similarly, the secondary attributes of the shortcut file (904) includes information of the selected images in order of their selection. Thus, when the user renders the shortcut file (904), the server (201) access the selected images Image 3, Image 6, Image 1, and Image 8 from their location according to the circular queue (905) and renders them according to their play speed.

Thus, the shortcut file can be created from a video, audio, series of image files, or series of shortcut files. This results in flexibility to create shortcut from any streaming and non-streaming content, as desired, and results in better user-experience.

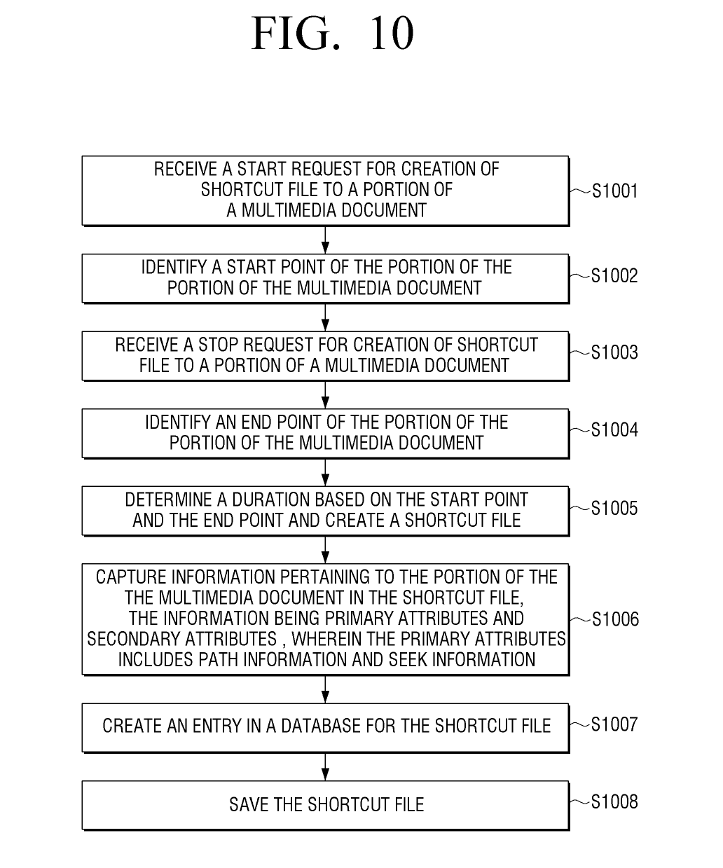

The order in which the methods is described in FIG. 10 to FIG. 12 is not intended to be construed as a limitation, and any number of the described method steps can be combined in any order to implement the method, or an alternative method. Additionally, individual steps may be deleted from the method without departing from the spirit and scope of the subject matter described herein. Furthermore, the method can be implemented in any suitable hardware, software, firmware, or combination thereof.

FIG. 10 illustrates an exemplary method for creating a shortcut to a portion of a multimedia document, in accordance with an embodiment of present disclosure.

At step s1001, a start request for creation of shortcut file to a portion of a multimedia document is received. For example, the SFC module (202) receives the start request from the shortcut request initiator module of the first client device (204-1). The start request can provided via various options such as a predefined key on a remote controller, audio input, and a touch based gesture input.

At step s1002, upon receiving the start request, a start point of the portion of the multimedia document is identified. For example, the SFC module (202) identifies a start point of the portion of the multimedia document (205).

At step s1003, a stop request for creation of shortcut file to the portion of the multimedia document is received. For example, the SFC module (202) receives the stop request from the shortcut request initiator module of the first client device (204-1). The stop request can provided via various options such as a predefined key on a remote controller, audio input, and a touch based gesture input.

At step s1004, upon receiving the stop request, an end point of the portion of the multimedia document is identified. For example, the SFC module (202) identifies an end point of the portion of the multimedia document (205).

At step s1005, upon identifying the start point and the end point, a duration is determined and a shortcut file is created. For example, the SFC module (202) creates a shortcut file (206) for the portion of the multimedia document (205). At step s1006, information pertaining to the portion of the multimedia document is captured in the shortcut file. For example, the SFC module (202) captures information pertaining to the portion of the multimedia document (205) in the shortcut file (206).

Accordingly, the shortcut file (206) includes primary attributes (207) and secondary attributes (208). The primary attributes include “path” information and “seek” information. The “path” information identifies a location of the multimedia document (205). The “seek” information identifies the portion of the multimedia document (205) on basis of the start point and end point. The secondary attributes include, but not limited to, pictorial representation of the shortcut file (206), a display message, a name pertaining to the shortcut file (206), a revised name pertaining to the shortcut file (206), a summary, information pertaining to play speed, information pertaining to Black-Out time, information pertaining to a type of player, a time of creation of the shortcut file (206), a time of modification of the shortcut file (206), information pertaining to sharing of the shortcut file (206), and information pertaining to security setting pertaining to the shortcut file (206).

At step s1007, an entry in a database is created for the shortcut file and information pertaining to the portion of the multimedia document. For example, the SFC module (202) creates an entry in a database (209) corresponding to the shortcut file (206) and information pertaining to the multimedia document (205). As would be understood, the entry provides a mapping relationship between the shortcut file (206) and the corresponding portion of the multimedia document (205).

At step s1008, upon creation of the entry, the shortcut file is saved. For example, the SFC module (202) saves the shortcut file (206). In one aspect of the disclosure, the shortcut file is saved at the same location at which the multimedia document is saved. In another aspect of the disclosure, the shortcut file is saved at a location different from the location at which the multimedia document is saved.

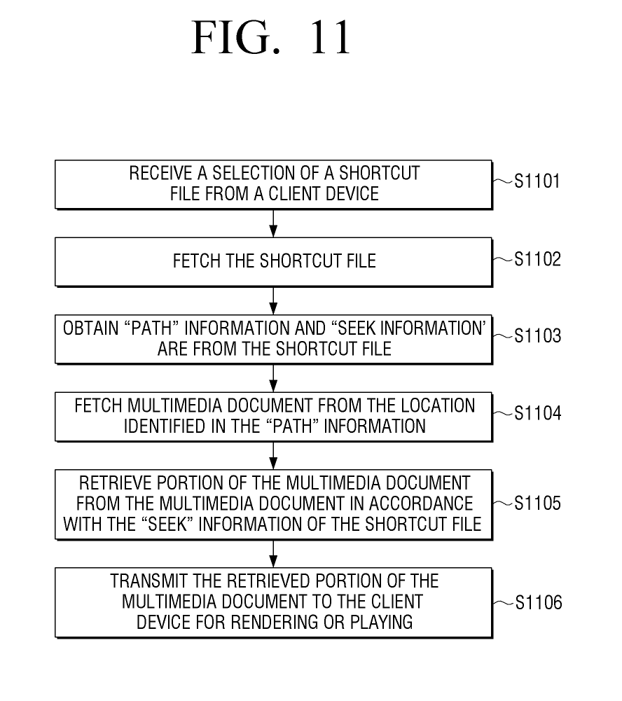

FIG. 11 illustrates a first exemplary method for accessing a portion of a multimedia document from the shortcut file, in accordance with an embodiment of present disclosure.

At step s1101, a selection of a shortcut file is received from a client device. For example, the SFA module (203) receives a selection of the shortcut file (206) from the second client device (204-2). The selection can provided via various options such as a predefined key on a remote controller, audio input, and a touch based gesture input.

At step s1102, upon receiving the selection, the shortcut file is fetched. For example, the SFA module (203) fetches the shortcut file (205). As described earlier, the shortcut file (205) can be saved at the server (201) or at the client device (204).

At step s1103, “path” information and “seek information’ are obtained from the shortcut file. The “path” information identifies a location of the multimedia document (205). The “seek” information identifies the portion of the multimedia document (205) on basis of the start point and end point. For example, the SFA module (203) obtains “path” information and “seek” information from the primary attributes of the shortcut file (206).

At step s1104, multimedia document is fetched from the location identified in the “path” information. For example, the SFA module (203) fetches the multimedia document (205) from the location as indicated in the “path” information of the shortcut file (206).

At step s1105, portion of the multimedia document is retrieved from the multimedia document in accordance with the “seek” information of the shortcut file. For example, the SFA module (203) retrieves the portion of the multimedia document (205) from the multimedia document (205) in accordance with the “seek” information of the shortcut file (206).

At step s1106, the retrieved portion of the multimedia document is transmitted to the client device for rendering or playing. For example, the SFA module (203) transmits the portion of the multimedia document (205) to the second client device (204-2). Upon receiving the portion of the multimedia document (205), a media rendering or playing application available on the second client device (204-2) renders or plays the portion of the multimedia document (205).

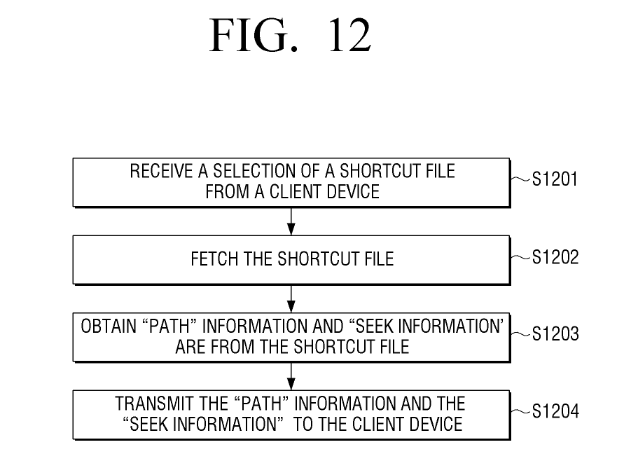

FIG. 12 illustrates a second exemplary method for accessing a portion of a multimedia document from the shortcut file, in accordance with an embodiment of present disclosure.

At step s1201, a selection of a shortcut file is received from a client device. For example, the SFA module (203) receives a selection of the shortcut file (206) from the second client device (204-2). The selection can provided via various options such as a predefined key on a remote controller, audio input, and a touch based gesture input.

At step s1202, upon receiving the selection, the shortcut file is fetched. For example, the SFA module (203) fetches the shortcut file (205). As described earlier, the shortcut file (205) can be saved at the server (201) or at the client device (204).

At step s1203, “path” information and “seek information’ are obtained from the shortcut file. The “path” information identifies a location of the multimedia document (205). The “seek” information identifies the portion of the multimedia document (205) on basis of the start point and end point. For example, the SFA module (203) obtains “path” information and “seek” information from the primary attributes of the shortcut file (206).

At step s1204, the “path” information and the “seek information’ are transmitted to the client device. For example, the SFA module (203) provides the “path” information and the “seek” information from the shortcut file (206) to the second client device (204-2).

The client device then fetches multimedia document from the location identified in the “path” information and retrieves portion of the multimedia document from the multimedia document in accordance with the “seek” information of the shortcut file. A media rendering or playing application in the client device then renders or plays the retrieved portion of the multimedia document.

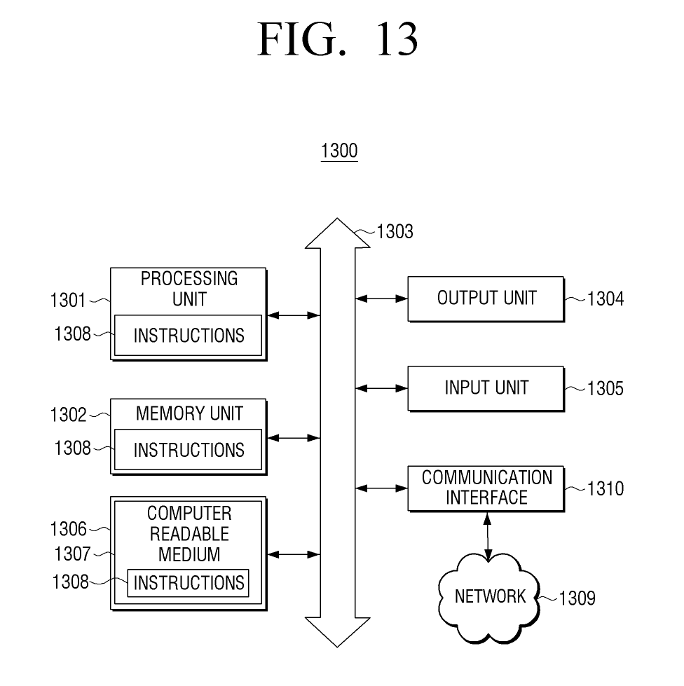

FIG. 13 illustrates a hardware configuration of an electronic device, in accordance with an embodiment of present disclosure.

Referring to FIG. 13, the electronic device (1300) can be the system (100) as illustrated in FIG. 1, the server (201), and the client devices (204) illustrated in FIG. 2. The electronic device (1300) can include a set of instructions that can be executed to cause the electronic device (1300) to perform any one or more of the methods, in accordance with the disclosure. The electronic device (1300) may operate as a standalone device or may be connected, for example, using a network to other computing systems or peripheral devices.

In a networked deployment, the electronic device (1300) may operate in the capacity of a server or as a client user computer in a server-client user network environment, or as a peer computing system in a peer-to-peer (or distributed) network environment. The electronic device (1300) can also be implemented as or incorporated into a variety of devices, which are capable of executing a set of instructions (sequential or otherwise) that specify actions to be taken by that device. Furthermore, while a single electronic device (1300) is illustrated in the figure, the term “system” shall also be taken to include any collection of systems or sub-systems that individually or jointly execute a set, or multiple sets, of instructions to perform one or more computer functions.

The electronic device (1300) may include a processing unit (1301) e.g., a central processing unit (CPU), a graphics processing unit (GPU), or both. The processing unit (1301) may be a component in a variety of systems. For example, the processing unit (1301) may be part of a standard personal computer or a workstation. The processing unit (1301) may be one or more general processors, digital signal processors, application specific integrated circuits, field programmable gate arrays, servers, networks, digital circuits, analogue circuits, combinations thereof, or other now known or later developed devices for analysing and processing data. The processing unit (1301) may implement a software program, such as code generated manually (i.e., programmed).

The electronic device (1300) may include a memory (1302), such as a memory (1302) that can communicate via a bus (1303). The memory (1302) may be a main memory, a static memory, or a dynamic memory. The memory unit (1302) may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory unit (1302) includes a cache or random access memory for the processing unit (1301). In alternative examples, the memory unit (1302) is separate from the processing unit (1301), such as a cache memory of a processor, the system memory, or other memory. The memory unit (1302) may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory unit (1302) is operable to store instructions executable by the processing unit (1301). The functions, acts or tasks illustrated in the figures or described may be performed by the programmed processing unit (1301) executing the instructions stored in the memory unit (1302). The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the electronic device (1300) may or may not further include an outputter (1304), such as an audio unit and/or a display. The examples of the display include, but are not limited to a liquid crystal display (LCD), an organic light emitting diode (OLED), a flat panel display, a solid state display, a cathode ray tube (CRT), a projector, a printer or other now known or later developed display device for outputting determined information. The output unit (1304) may act as an interface for the user to listen/see the functioning of the processing unit (1301), or specifically as an interface with the software stored in the memory (1302) or in a removable storage device. Additionally, the electronic device (1300) may include an inputter (1305) configured to allow a user to interact with any of the components of system (300). The inputter (1305) may be a number pad, a keyboard, or a cursor control device, such as a mouse, or a joystick, remote control or any other device operative to interact with the electronic device (1300). Sometimes, a single IO unit, such a touch screen display, can serve the function of the outputter (1304) as well as the inputter (1305).

The electronic device (1300) may also include a disk or optical driver (1306). The disk driver (1306) may include a computer-readable medium (1307) in which one or more sets of instructions (1308), e.g. software, can be embedded. Further, the instructions (1308) may embody one or more of the methods or logic as described. In a particular example, the instructions (1308) may reside completely, or at least partially, within the memory (1302) or within the processing unit (1301) during execution by the electronic device (1300). The memory unit (1302) and the processing unit (1301) also may include computer-readable media as discussed above.

The present disclosure contemplates a computer-readable medium that includes instructions (1308) or receives and executes instructions (1308) responsive to a propagated signal so that a device connected to a network (1309) can communicate voice, video, audio, images or any other data over the network (1309). Further, the instructions (1308) may be transmitted or received over the network (1309) via a communication port or interface (“communicator”) (1310) or using the bus (1303). The communication port or interface (1310) may be a part of the processing unit (1301) or may be a separate component. The communication port or interface (1310) may be created in software or may be a physical connection in hardware. The communication port or interface (1310) may be configured to connect with the network (1309), external media, the outputter (1304), or any other components in the electronic device (1300) or combinations thereof. The connection with the network (1309) may be a physical connection, such as a wired Ethernet connection or may be established wirelessly as discussed later. Likewise, the additional connections with other components of the electronic device (1300) may be physical connections or may be established wirelessly. The network (1309) may alternatively be directly connected to the bus (1303).

The network (1309) may include wired networks, wireless networks, Ethernet Audio Video Bridging (AVB) networks, or combinations thereof. The wireless network may be a cellular telephone network, an 802.11, 802.16, 802.20, 802.1Q or Worldwide Interoperability for Microwave Access (WiMax) network. Further, the network (1309) may be a public network, such as the Internet, a private network, such as an intranet, or combinations thereof, and may utilize a variety of networking protocols now available or later developed including, but not limited to Transmission Control Protocol/Internet Protocol (TCP/IP) based networking protocols.

In an alternative example, dedicated hardware implementations, such as application specific integrated circuits, programmable logic arrays and other hardware devices, can be constructed to implement various parts of the electronic device (1300).

The present disclosure can be implemented on a variety of electronic and computing systems. For instance, one or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

Any one or more of the methods or logic as described may be implemented in part by software programs executable by a computing system. Further, in a non-limited example, implementations can include distributed processing, component/object distributed processing, and parallel processing. Alternatively, virtual computing system processing can be constructed to implement various parts of the electronic device (1300).

The electronic device (1300) is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof.

The foregoing example embodiments and advantages are merely examples and are not intended to be limiting. The present disclosure can be readily applied to other types of apparatuses. Also, the description of the example embodiments of the present disclosure is intended to be illustrative, and not to limit the scope of the claims.

What is claimed is:

1. An electronic device, comprising:
a display;
a communicator configured to communicate with a server; and
a processor configured to:
obtain information on a start point and an end point to create a shortcut file of a portion of a content displayed on the display according to a user input and transmit the information to the server through the communicator, and
in response to the content being selected according to a user input, receive, from the server, information on a shortcut file on a portion of the content created based on information on the start point and the end point and a pre-stored different shortcut file relating to the content, and provide the information to the display.

2. The electronic device as claimed in claim 1, wherein the created shortcut file comprises:
primary attributes including path information and seek information corresponding to a portion of the content, wherein the path information is information for identifying a location of the content and the seek information is information for determining a duration of the content based on the start point and the end point, and
secondary attributes including metadata information and security setting information with respect to the shortcut file, wherein the security setting defines a level able to approach to a portion of the content corresponding to the shortcut file.

3. The electronic device as claimed in claim 1, wherein the start point and the end point, in response to the content being a video and a streaming video, are starting time and ending time of a portion of the content, and
in response to the content being a plurality of images, the start point and the end point are a first image and a last image from among images selected from among the plurality of images.

4. The electronic device as claimed in claim 2, wherein the processor is configured to control the display to provide to the display a graphic object corresponding to the shortcut file and the different shortcut file together with the content, and the graphic object further comprises an editing menu to edit the primary attributes and the secondary attributes.

5. The electronic device as claimed in claim 2, wherein the processor, in response to selecting the shortcut file from the display, is configured to control the display to obtain, through the communicator, reproduction information on a portion of the content corresponding to the shortcut file from the path information, and reproduce a portion of the content during the duration which is determined based on the seek information.

6. The electronic device as claimed in claim 1, further comprising:
an inputter,
wherein the processor is configured to control the inputter to receive a user command through at least one of a preset user manipulation key input, gesture input, and audio input from a user.

7. The electronic device as claimed in claim 1, wherein the pre-stored different shortcut file relating to the content is created by a request of the electronic device and the another electronic device.

8. A method for creating and controlling a shortcut file of a content of an electronic device, the method comprising:
obtaining information with respect to a start point and an end point to create a shortcut file of a portion of a content displayed on a display according to a user input;
transmitting the obtained information to a server device through a communicator; and
in response to the content being selected according to a user input, receiving, from the server device, information regarding a shortcut file with respect to a portion of the content and information regarding a pre-stored different shortcut file relating to the content based on information regarding the start point and the end point and providing the shortcut file and the different shortcut file to the display.

9. The method as claimed in claim 8, wherein the created shortcut file comprises primary attributes including path information and seek information corresponding to a portion of the content, the path information is information for identifying a location of the content, and the seek information is information for determining a duration of the content based on the start point and the end point, and
wherein the created shortcut file further comprises secondary attributes including metadata information and security setting information on the shortcut file, and the security setting defines a level able to approach to a portion of the content corresponding to the shortcut file.

10. The method as claimed in claim 8, wherein the start point and the end point, in response to the content being a video and a streaming video, are starting time and ending time of a portion of the content, and
in response to the content being a plurality of images, the start point and the end point are a first image and a last image from among images selected from among the plurality of images.

11. The method as claimed in claim 9, wherein the providing further comprises:
in response to selecting the content from the display, providing to the display a graphic object corresponding to the shortcut file and the different shortcut file along with the content,
wherein the graphic object further comprises an editing menu to edit the primary attributes and the secondary attributes.

12. The method as claimed in claim 9, wherein the providing further comprises, in response to selecting the shortcut file from the display, obtaining reproduction information on a portion of the content corresponding to the shortcut file from the path information, and providing a portion of the content during the duration which is determined based on the seek information.

13. The method as claimed in claim 8, wherein the user input is at least one of a preset user manipulation key input, gesture input, and audio input from a user.

14. A method for controlling a shortcut file of a content from a server device, the method comprising:
receiving, from an electronic apparatus, a request for a start point and an end point of a portion of a content;
creating a shortcut file on the portion of the content based on the start point and the end point and storing the shortcut file in database; and
in response to a request for reproduction on the content being received from the electronic apparatus, transmitting information on the created shortcut file and a pre-stored different shortcut file relating to the content.

15. The method as claimed in claim 14, wherein the created shortcut file comprises primary attributes including path information and seek information corresponding to a portion of the content,
wherein the path information is information for identifying a location of the content and the seek information is information for determining a duration of the content based on the start point and the end point.

16. The method as claimed in claim 15, wherein the created shortcut file further comprises secondary attributes including metadata information and security setting information with respect to the shortcut file,
wherein the security setting defines a level able to approach to a portion of the content corresponding to the shortcut file.

17. The method as claimed in claim 16, comprising:
storing the created shortcut file to at least one of database of the server device and external database; and
wherein the primary attributes and secondary attributes are editable, and in response to receiving an editing result of the primary attributes and the second attributes from the electronic device, the result of the editing is updated and stored in the database.

18. The method as claimed in claim 14, wherein the start point and the end point, in response to the content being a video and streaming video, is starting and ending time of a portion of the content, and in response to the content being a plurality of images, the start point and the end point is a first image and a last image from among images selected from the plurality of images.

19. The method as claimed in claim 14, further comprising:
in response to receiving a request for reproducing the shortcut file from the electronic device, obtaining reproduction information on a portion of the content from the path information and transmitting the information to the electronic device.

20. The method as claimed in claim 14, further comprising:
in response to receiving a request for reproducing the shortcut file from the electronic device, transmitting the primary attributes information to the electronic device,
wherein the electronic device acquires reproducing information on a portion of the content from the path information, based on the primary attributes information.
